(19) United States
(12) Patent Application Publication
(10) Pub. No.: US 2018/0315358 A1
(43) Pub. Date: Nov. 1, 2018

(54) LED PANEL

(71) Applicant: HARTING ELECTRONICS GMBH, Espelkamp (DE)

(72) Inventor: Hartmuth Schmidt, Ostercappeln (DE)

(21) Appl. No.: 15/964,002

(22) Filed: Apr. 26, 2018

(30) Foreign Application Priority Data
Apr. 27, 2017 (DE) 10 2017 109 103.3

(51) Int. Cl. G09F 19/22; H01R 12/71; H01R 13/518; G09F 9/302; G09F 9/33

(52) U.S. Cl. CPC G09F 19/226; H01R 12/716; F21Y 2115/10; G09F 9/3026; G09F 9/33; H01R 13/518

(57) ABSTRACT

The disclosure relates to an LED panel, which has at least one illuminant. The panel also has a contact-connection device or means, which can be used to electrically connect the panel to at least one further panel or an entire panel wall, such as a display board or an advertising wall, for example. The individual panel further has a unit, which can be used to displace the contact-connection device or means such that said panel can be repaired and replaced without difficulty.

### BACKGROUND

### Technical Field

The disclosure relates to an LED panel which has at least one illuminant.

LED panels of this kind can be combined to form display panels. Display panels are used in sports stadiums or are mounted on buildings for advertising purposes, for example.

### Description of the Related Art

DE 20 2010 008 460 U1 shows a panel that can be mechanically connected to a further panel by way of a connecting means to form a display panel. Each individual panel contains a passage opening serving for individual power supply.

The connecting means of DE 20 2010 008 460 U1 are separate parts, which makes the installation of display panels composed of such panels difficult.

The panels of DE 20 2010 008 460 U1 are electrically wired on the rear side. Wiring of this kind is susceptible to moisture, which increases the susceptibility of a display panel consisting thereof to fail.

Furthermore, plug-type connector systems that can be used to connect different plug-type connectors and contacts are known. Particularly in event technology, it is often necessary to connect a plurality of different signal and power contacts during the assembly and installation of music, lights and image systems, for example. In applications of this kind, signal plug-type connectors and power plug-type connectors or contacts can expediently be combined by way of such a plug-type connector system. Therefore, instead of assembling a plurality of plug-type connections, only one plug-type connector system has to be plugged.

In particular cases, these plug-type connector systems are installed directly in the application. Individual display modules of a video projection screen are connected to one another, for example, not by way of cables but instead have integrated plug-type connector systems. The modules can thus be plugged into one another and connected directly. An additional connection via a cable or extra lines is no longer necessary. A plug-type connector system of this kind is disclosed in DE 20 2016 104 271 U1, for example.

### BRIEF SUMMARY

Embodiments of the present invention provide an LED panel that simplifies the design of a display panel and that is not susceptible to environmental influences.

Embodiments of the invention relate to an LED panel, which has at least one illuminant. The panel furthermore has a contact-connection device or means, which can be used to electrically connect the panel to at least one further panel. The contact-connection device or means is a multipole plug-type connector. The panel further has a unit, which can be used to displace the contact-connection device or means.

The LED panel may be, for example, a constituent part of a large display panel, a panel wall or an advertising space. The known panels have a front side and a rear side. The unit is received inside, between the front side and the rear side. Said unit acts on the contact-connection device or means received inside.

The illuminant is preferably LEDs, wherein other equivalent illuminants are also conceivable.

The contact-connection device or means is a plug-type connector, in particular a multipole plug-type connector. Transmission of power and/or signals and/or data is also possible due to the multipole design. In one particular configuration, the contact-connection device or means is a hybrid plug-type connector, which has at least one, in particular two, RJ45 plug-type connectors and at least one, in particular five, power contacts. The power contacts are contacts, which, due to their configuration (for example material and/or thickness and/or structure), are designed to transmit high currents of at least 10 A, in particular of at least 20 A and preferably of at least 30 A. These currents serve for optimum power transmission when a plurality of panels are intended to be connected to one another.

The contact-connection device or means is necessary to electrically connect different panels to one another. A corresponding display panel is created only by the connection between the panels. However, it is difficult to repair an individual panel due to this connection by the contact-connection device or means.

The unit according to embodiments of the invention, which has the panel, solves this problem by virtue of it acting on the contact-connection device or means and by it being able to displace the contact-connection device or means between different states.

In one particular configuration, the unit makes it possible to displace the contact-connection device or means vertically between a connected state and a disconnected state. The ability of the contact-connection device or means to be displaced simplifies the repair of an individual panel.

In one particularly advantageous configuration, in the connected state, the unit both electrically and mechanically connects the panel to a further panel. This ensures a secure, stable connection between the individual panels of an entire panel wall.

In a further particularly advantageous configuration, in the disconnected state, the unit mechanically and electrically disconnects the panel from a further panel. In this state, the individual disconnected panel is released mechanically, is free of pulling forces and has no current. Consequently, repair works to the individual panel are possible without posing a risk to humans and to the panel.

In the disconnected state, the individual panel can advantageously be removed completely from the group of a plurality of panels, such as a display panel or an advertising wall, for example. This simplifies the replacement of a complete panel in the event of a complete fault.

The unit is a mechanical unit. As a result, the operation of the unit is not dependent on current. The unit preferably functions by interacting with an actuator having an associated receptacle and a plurality of guides. In this case, a distinction should be made between the guides. There are the so-called vertical guides, which permit the movement of the unit, in particular the displacement of the contact-connection device or means. There is also the lever guide, which transmits the movement of the actuator to the unit and also to the vertical guide, such that the unit and therefore the contact-connection device or means are displaced vertically depending on the movement of the actuator. The lever guide consists, inter alia, of the actuator and the receptacle thereof and is able to be received on or in the unit in such a way that it transmits the force required to displace the contact-connection device or means. The configuration of the vertical guide and the lever guide is explained in more detail below.

The vertical guides are grooves as guide rails in which the mechanical unit can slide. The vertical guides serve for stabilization, position securing and rectilinear guidance of the unit. In order that the simple principle of the T-groove guide functions in an optimum manner, the T-grooves have to be manufactured very precisely, since tolerances can lead to clearance or to seizing of the unit. Too much clearance between the groove and the spring can lead, during displacement, to the contact-connection device or means not finding one another and jamming. The release of the unit from the vertical guide is likewise conceivable. In contrast, too little clearance leads to seizing of the spring-groove guide, as a result of which the contact-connection device or means would no longer be displaced.

The unit is advantageously also guided on each of its two sides in a spring-groove guide, said sides of the unit being located on both sides of the contact-connection device or means. The groove is preferably a T-groove, which is cost-effective to manufacture. In order to achieve an optimum function, this groove is typically reworked mechanically in a precise manner, for example using a CNC milling machine, since tolerances can lead to clearance or to seizing of the unit. This mechanical reworking increases the production costs and reduces the advantage of the cost-effective manufacture of a T-groove.

In one particularly advantageous embodiment, the underside of the unit is of slightly arch-shaped configuration. The sliding movement during displacement is demonstrably smooth due to the rather pointwise support due to the arch shape of the unit. Greater tolerances can be permitted in the T-groove because the arch-shaped configuration of the displacement unit permits only punctiform abutment locations. Seizing of the unit in the T-groove is reliably prevented without the T-groove having to be reworked mechanically. As a result, less effort is required for a user to move the unit between the different positions.

Overall, the unit together with the contact-connection device or means is configured in a geometric manner, preferably in an approximately rectangular manner, such that there is a simple and easy-to-handle contour for the receptacle in a panel.

The lever guide is preferably a groove having a guide device or means, wherein the guide device or means has a connection to the actuator. The connection may be, for example, a droplet-shaped element, which is connected with the pointed side to the guide device or means of the lever guide and with the bulbous side to the actuator. The guide device or means of the lever guide may be, for example, a small plate, in particular a plastic plate or a metal plate, which can be moved in the groove and to which the connection is secured.

In an alternative or supplementary configuration of the lever guide, it is a partially circular recess. The recess is formed in the sense of a depression and is formed directly by injection molding, for example, or produced in another production method. The partial circle has a radius between 90° and 180°, in particular between 100° and 170°, preferably between 110° and 160°. In this case, the peak of the partial circle is aligned with one of the side faces, for example on the right or the left, of the contact-connection device or means. Due to the partially circular configuration, the actuator is limited in its movement space such that a stop function like in the groove is provided at the end of the partial circle. This configuration prevents, just like the groove, over rotation of the actuator. To hold the actuator securely in the partially circular recess, said recess has another passage opening through which the actuator protrudes in certain areas. The actuator can therefore be actuated from one side of the panel or even from both sides.

The actuator itself has a receptacle. Said receptacle is accessible at least from one and/or from both sides and is fully functional. The sides mentioned here refer to the front side and to the rear side, respectively, of the panel. The receptacle is configured in such a way that it can receive an auxiliary means or a tool, preferably a hexagon key or a screwdriver or an individual tool having a negative shape of the receptacle as the tip. In this case, the receptacle can protrude from the plane of the actuator or can be identical thereto in terms of height.

In a particularly advantageous configuration, the unit, more precisely the actuator, can be displaced by a tool. The tool is preferably a hexagon key, as is sufficiently well known in the prior art, or a screwdriver or an individual tool having a negative shape of the receptacle of the actuator as the tip.

Other shapes of the receptacle that is suitable for receiving an auxiliary means or a tool for shifting the actuator between the disconnected state and the connected state are also conceivable. The tool serves for being able to shift the unit between the disconnected state and the connected state.

In an alternative or supplementary configuration of the actuator, it is configured in such a way that purely manual operation is possible. For this, the actuator is instead formed with a receptacle having a handle, for example in the sense of a rotatable knob or a semicircular handle or bar or similar. This kind of actuator simplifies handling for the user even further, since said handling is possible without tools.

The actuator preferably has a display with a clear label for the user, for example “up” and “down,” “disconnected” and “connected” or “on” and “off” or similar. This also increases safety, since it is quickly apparent whether the panel is still connected and possibly still under load or not.

The unit can advantageously be operated from the front side and/or the rear side of the panel. That is to say that the unit can be displaced from an arbitrary side. In the case of repair, this offers the advantage that the arduous task of finding a hole for the person does not have to be undertaken first when the panels are mounted closely on a wall, for example.

In a particularly advantageous configuration, the contact-connection device or means is a hybrid plug-type connector for transmitting power and/or signals and/or data.

The contact-connection device or means, and hence the panel, can be used in a flexible manner due to this combination.

One particular configuration makes provision for the contact-connection device or means to be a modular plug-type connector, in particular a modular hybrid plug-type connector having individual modules for transmitting power and/or data and/or signals. The modular configuration makes a flexible application for the worker possible when, for example, only voltages or only signals or only data are intended to be transmitted via an external plug-type connector. Through the configuration using individual modules, the worker can finish the respectively required module in the contact-connection device or means and the plug-type connector in accordance with the requirements. Furthermore, when using individual modules, so-called underpopulating is also conceivable, such that it suffices when only at least one individual module, depending on the user's wishes, is installed. This option makes it possible for the user who would like to utilize the panel to achieve a high degree of individualization.

Modular plug-type connectors and plug-type connectors having plug-type connector modules are known in the prior art, for example from DE 20 2011 050 643 U1, EP 2 917 974 A1, EP 0 860 906 A2, DE 10 2013 106 279 A1. Plug-type connector modules of this kind are required as a constituent part of a plug-type connector modular system in order to be able to adjust a plug-type connector, in particular a heavy industrial plug-type connector, flexibly to specific requirements with respect to signal and energy transmission, for example between two electrical devices.

For this purpose, plug-type connector modules are usually used in corresponding holding frames, which are sometimes also referred to as articulated frames, module frames or modular frames. The holding frames therefore serve to receive a plurality of plug-type connector modules of the same type and/or also different plug-type connector modules and to fasten them securely to a surface and/or a device wall and/or in a plug-type connector housing or the like. Instead of a frame, a contact carrier is also suitable for receiving the plug-type connector modules, said contact carrier then also being able to be used in connection with the plug-type connector modules as a contact-connection device or means.

The plug-type connector modules generally have in each case a substantially cuboidal insulating body or a cuboidal housing. This insulating body or housing can serve, for example, as a contact carrier and can receive and fix contacts of a wide variety of types. The function of a plug-type connector formed thereby is thus very flexible. It is possible for pneumatic modules, optical modules, modules for transmitting electrical energy and/or electrical analogue and/or digital signals, for example, to be received in the respective insulating body or housing and for them to be thus used in the plug-type connector modular system. Plug-type connector modules are also increasingly taking over measurement and data tasks.

The modular configuration of the contact-connection device or means broadens the field of use, since it can thus be further used simultaneously for transmitting power and/or data and/or signals and can also be configured in a flexible manner. Due to the modular configuration, also only individual plug-type connector modules can be contact-connected instead of the entire plug-type connector always having to be contact-connected. As a result, the convenience and the flexibility of the applicability of the panel is increased. Furthermore, fast replacement in the event of damage is possible.

Independently of the variants of the displacement units and the actuators thereof described above, the position that the contact-connection device or means can reach by way of the displacement unit is influenced by a plurality of assembly and manufacturing tolerances. The actual plug position achieved by the outstretched displacement unit has to be observed critically here.

In the outstretched state of the displacement unit, the two contact-connection device or means are ideally plugged together completely without a significant gap. The insulating bodies of the contact-connection device or means are in this case located opposite one another and thus allow an optimum working position of the electrical contacts. The point at which the two insulating bodies of the contact-connection device or means bear against one another is the maximum point that the contact-connection device or means is allowed to reach by way of the outstretched displacement unit because otherwise a mechanical collision occurs. In order to prevent this, the displacement unit has to be positioned such that said point is reached only when all the maximum tolerances coincide. However, when all the possible minimum tolerances coincide, this technical design results in the contact-connection device or means possibly no longer reaching the optimum plug position, which is limited to a few millimeters, in particular in signal contacts.

In order to balance the tolerances in an optimum manner and to ensure secure contact-connection at all times, the unit advantageously has a spring, in particular a torsion spring and preferably a torsion spring with prestress. Torsion springs are known in the prior art and are also known there by the name leg spring or rotary spring. Alternatively, flat spring plates can also fulfill the desired function. In a further alternative or supplementary configuration, the plate described above takes over the spring function. For this, the plate is configured as follows. Said plate is produced, for example, in a stamping process or another cutting process. During production, from the flat plate remains a circumferential frame, a resilient inner contour and an actuator receptacle. The resilient contour likewise fulfills the required spring properties, such as a torsion spring or a flat spring plate. The resilient contour is preferably mirror-symmetrical on both sides of the actuator receptacle, which is preferably circular. The mirror-symmetry makes the optimum spring action of the plate possible.

The spring used is configured in the flattest construction possible in order to take up as little space as possible within the actuator. Said spring secures the correct displacement of the contact-connection device or means into the optimum plug position. In order to guarantee this, the force of the spring is greater than the plugging force of the contact-connection device or means to be absorbed.

If the displacement unit is now positioned such that maximum tolerances would inevitably have to lead to the collision of the contact-connection device or means, there is no mechanical blocking due to the influence of the spring, because the remaining plug distance is now picked up by the spring.

As standard, conductors are short and connected as directly as possible in order to reduce the costs in the production and to impart a clean, tidy installation effect. Within the unit, the connected conductors are in each case subjected to the displacement movement of the unit. In particular, short conductor lengths significantly increase the risk of contact interruptions, conductor compressions or Litz-wire breakage on account of elongation and compression of the conductors during actuation of the unit. In order to reduce this, the unit advantageously has a length compensation.

The length compensation may be, for example, a vertically or horizontally arranged loop in the conductor, with the result that said conductor has a greater overall length within the unit. In this case, it is possible to use different configurations within a unit in order to save as much space as possible. In order to secure the lines at least in certain regions, the unit has small recesses in which the conductors can each be fixed by a fastening device or means. The fastening device or means is, for example, a cable clamp or a cable tie or something similar suitable for fastening conductors. The length compensation significantly reduces the risk of contact interruptions, conductor compressions or Litz-wire breakage without significantly increasing the assembly outlay in the process.

### BRIEF DESCRIPTION OF THE SEVERAL VIEWS OF THE DRAWINGS

An exemplary embodiment of the invention is illustrated in the drawings and will be explained in greater detail below. In the drawings:

FIG. 1 shows a plan view of a contact-connection device or means and a unit of a panel;

FIG. 2 shows a further plan view of a contact-connection device or means and a unit of a panel;

FIG. 3a)-d) shows an overview of the states of a panel; and

FIG. 4 shows a perspective illustration of a contact-connection device or means and a unit of a panel.

The figures contain partially simplified, schematic illustrations. In some instances, identical reference symbols are used for elements which are similar but may not be identical. Different views of the same elements may be drawn to different scales.

### DETAILED DESCRIPTION

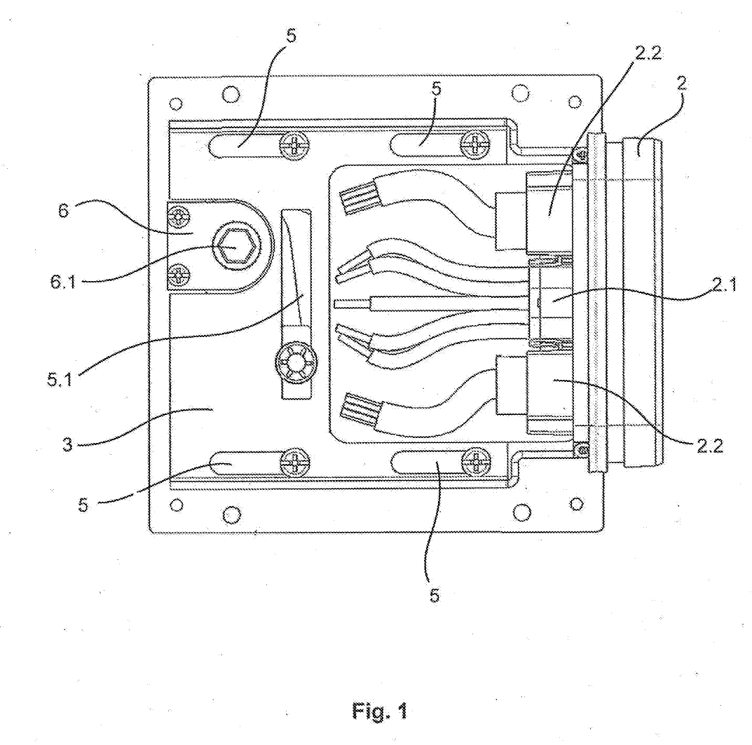

FIG. 1 shows a plan view of a contact-connection device or means 2 and a unit 3 of a panel 1. In this case, the contact-connection device or means 2 and the unit 3 are arranged opposite one another. The unit 3 and hence also the contact-connection device or means 2 are in this case illustrated in a disconnected state T.

The contact-connection device or means 2 comprises or consists of a plug-type connector, in particular of a hybrid plug-type connector. In this embodiment, the plug-type connector has two plug-type connectors for signal/data transmission 2.2, wherein in this case RJ45 plug-type connectors are used. The contact-connection device or means 2 furthermore has a plug-type connector for power transmission 2.1 using five power contacts. In this case, the plug-type connector for power transmission 2.1 is arranged between the two plug-type connectors for signal/data transmission 2.2. Corresponding conductors are arranged at the respective plug-type connectors, said conductors being illustrated in capped form purely for illustrative reasons in order that the conductors can be easily identified.

The unit 3 is a mechanical unit. The unit 3 comprises or consists of an actuator 6, a receptacle 6.1 and a plurality of guides. In FIG. 1, the unit 3 has four vertical guides 5 and one lever guide 5.1. There are two vertical guides 5 arranged behind one another on each side of the unit 3. These two vertical guides 5 are furthermore parallel to the other two vertical guides 5. The vertical guides 5 are grooves as guide rails with corresponding guide bodies. The guide bodies are firmly mounted screws, for example. The vertical guides 5 serve for stabilization, position securing and rectilinear guidance of the unit 3.

The lever guide 5.1 is a groove having a guide device or means, wherein the guide device or means has a connection to the actuator 6. The connection may be, for example, a droplet-shaped element, which is connected with the pointed side to the guide device or means of the lever guide 5.1 and with the bulbous side to the actuator 6. The guide device or means of the lever guide 5.1 may be, for example, a small plate 4, in particular a metal plate, which can be moved in the groove and to which the connection is fastened.

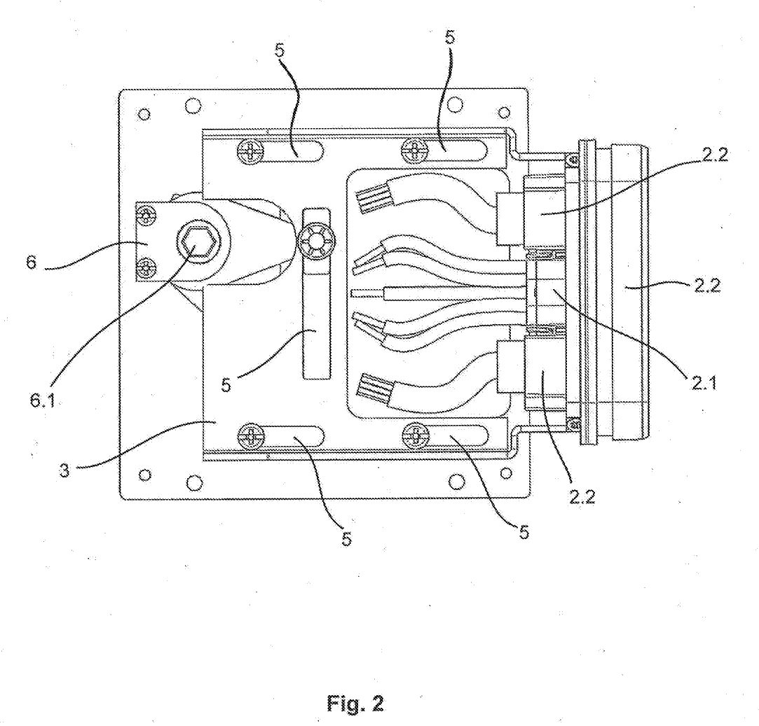

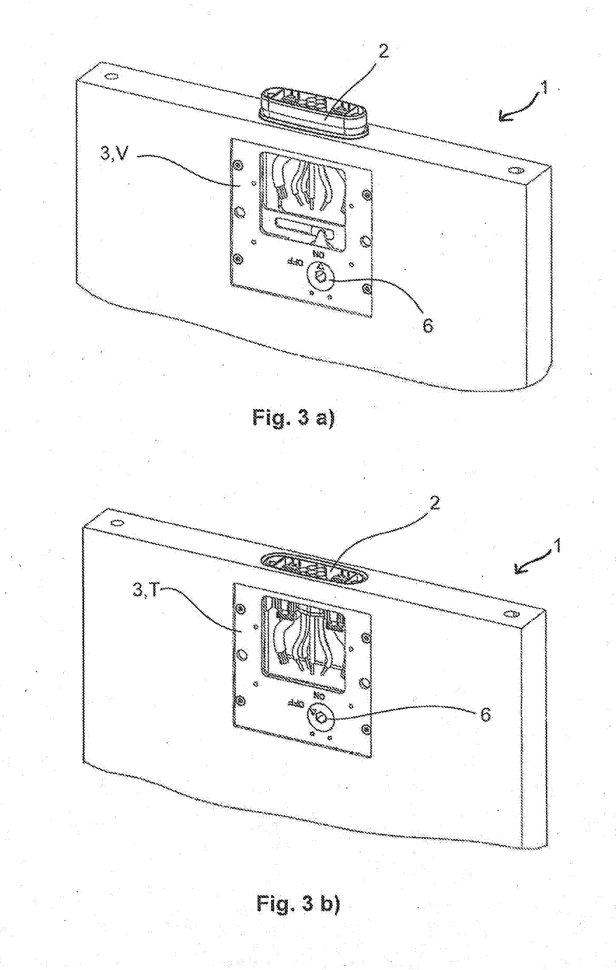

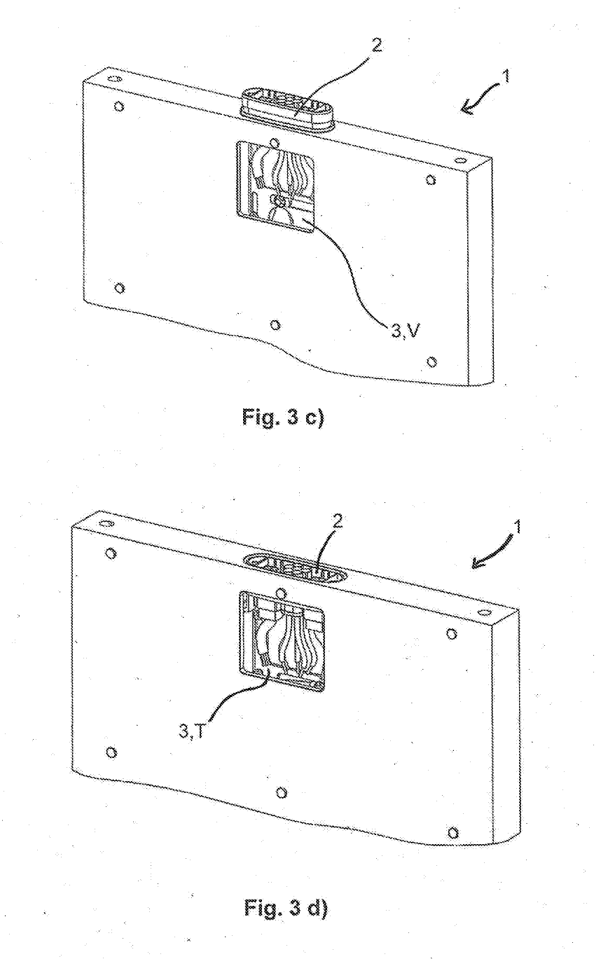

The actuator 6 can be either in a connected state V or in a disconnected state T. These two states are shown again more clearly in FIG. 3. In the disconnected state T (FIG. 1), the contact-connection device or means 2 is closer to the unit 3 than in the connected state V, as is illustrated in FIG. 2.

The actuator 6 has a receptacle 6.1. Said receptacle 6.1 is accessible from both sides and is fully functional. The receptacle 6.1 is configured such that it can receive a tool, preferably a hexagon key. Other shapes of the receptacle 6.1 that is suitable for receiving an auxiliary means or a tool for shifting the actuator 6 between the disconnected state T and the connected state V are also conceivable. The tool serves for being able to shift the unit 3 between the disconnected state T and the connected state V. For this, the actuator 6 has, as illustrated in FIG. 3, a display with a clear label, for example “up” and “down”, “disconnected” and “connected” or “on” and “off”.

Overall, the unit 3 is configured together with the contact-connection device or means 2 in an approximately rectangular manner, such that a simple contour is present for the receptacle in a panel as well.

FIG. 2 shows the same combination of the unit 3 and the contact-connection device or means 2. In contrast to FIG. 1, the combination in FIG. 2 is illustrated in the connected state V. In the connected state, the contact-connection device or means 2 protrudes further beyond the unit 3 than in the disconnected state T.

FIG. 3 is divided into four elements: a), b), c) and d). Here, FIG. 3a) and FIG. 3b) each show a panel 1 from the rear side and FIG. 3c) and FIG. 3d) show a panel 1 from the front side.

In all four illustrations, the panel 1 has a unit 3 and a contact-connection device or means 2, as illustrated in FIG. 1 and FIG. 2.

In FIG. 3a), the panel 1 can be seen from the rear side. In this view, the mechanical configuration of the unit 3 cannot be seen. Instead, the current position of the actuator 6 and hence of the unit 3 and of the contact-connection device or means 2 can be seen, since this side of the actuator 6 has the label “on” and “off” mentioned above. In this case, “on” means that the contact-connection device or means 2 and the unit 3 are in the connected state V, as FIG. 3a) shows. This state is shown by the protrusion of the panel 1 through the contact-connection device or means 2. In this state, two panels are firmly connected to one another and can thus form the panel wall, display panel or advertising board mentioned at the outset.

In FIG. 3b), the panel 1 can likewise be seen from the rear side. In contrast to FIG. 3a), the actuator 6, the contact-connection device or means 2 and the unit 3 are in the disconnected state T. This is shown by the position “off” of the actuator 6 and the low final position of the contact-connection device or means 2 flush with the panel 1. In this set-up, both the entire panel 1 and also only the contact-connection device or means 2 and the unit 3 or only individual component parts, such as conductors, for example, can be replaced. In the disconnected state T, this is possible on account of the omission of the high pulling forces, which otherwise restrict repairs to the most narrow space.

FIG. 3c) corresponds to FIG. 3a) and FIG. 3d) corresponds to FIG. 3b), but respectively observed from the front side of the panel 1.

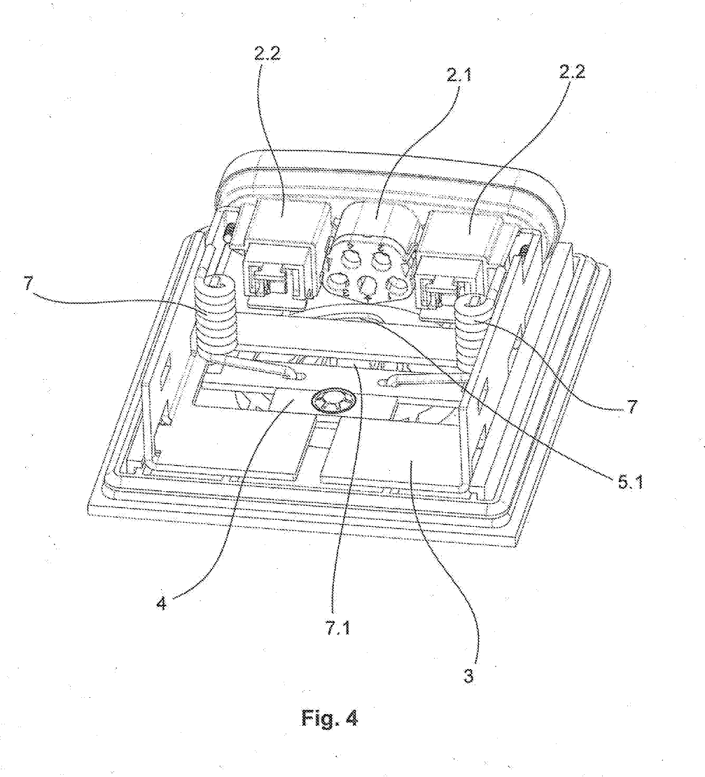

FIG. 4 shows a perspective illustration of a contact-connection device or means 2 and a unit 3 of a panel 1. The unit 3 and hence also the contact-connection device or means 2 are in this case illustrated in a disconnected state T. The contact-connection device or means 2 in FIG. 4 is identical to the contact-connection device or means 2 from FIG. 1. In this embodiment, said contact-connection device or means 2 also has two plug-type connectors for signal/data transmission 2.2, wherein these are advantageously RJ45 plug-type connectors, and one plug-type connector for power transmission 2.1 with advantageously five power contacts. No conductors are arranged at the respective plug-type connectors. This serves for illustrative purposes for a better and clearer illustration of the constituent parts of the unit 3.

The unit 3 is a mechanical unit. The unit 3 comprises or consists of an actuator 6, a receptacle 6.1 and a plurality of guides. In FIG. 4, the unit 3 has two vertical guides in the form of spring-groove guides and one lever guide 5.1.

The lever guide 5.1 of FIG. 4 is a partially circular recess, which is likewise connected to the actuator 6 by a droplet-shaped connection and a plate 4, in particular a metal plate. The recess is formed in the sense of a depression and is formed directly by injection molding, for example, or produced in another production method. The partial circle has a radius of approximately 150°. In this case, the peak of the partial circle is aligned with the side face, in this case on the right, of the contact-connection device or means 2.

Due to the partially circular configuration, the actuator 6 is limited in its movement space such that a stop function like in the groove is provided at the end of the partial circle. To hold the actuator 6 securely in the partially circular recess, said recess has another passage opening through which the actuator 6 protrudes in certain areas. The actuator 6 can therefore be actuated from one side of the panel 1 or even from both sides. The actuator 6 is actuated as described in the other figures.

FIG. 4 also shows another two spring elements 7 in the form of torsion springs. Said torsion springs 7 are arranged with one on one side wall, in this case on the right, and one on the other side wall, in this case on the left, of the unit 3. In this case, a spring arm and the wound region bear on the side wall; the other spring arm is hooked into a displacement plate 7.1. The displacement plate 7.1 is received in a movement space. The movement space of the displacement plate 7.1 is the region in which the displacement plate 7.1 can be displaced.

The rest state of the displacement plate 7.1 is at the end of the movement space, which is at a further distance from the plug side of the contact-connection device or means 2. In the illustration, the two spring elements 7 and the displacement plate 7.1 are in the rest state. During plugging of the contact-connection device or means 2, which is not shown here, the displacement plate 7.1 is slid from its rest position in the direction of the plug side. When the displacement plate 7.1 reaches the end close to the plug side, the contact-connection device or means 2 contact-connects a contact-connection device or means of a further panel. The spring elements 7 are oriented such that they counteract the plugging force, that is to say the mechanical force for contact-connecting a further contact-connection device or means. The ideal contact-connection point is therefore reached reliably and mechanical blocking is prevented.

Even though various aspects or features of the invention are shown respectively in combination in the figures, it is clear to the person skilled in the art—unless stated otherwise—that the illustrated and discussed combinations are not the only ones possible. In particular, mutually corresponding units or feature complexes from different exemplary embodiments can be exchanged with one another.

Moreover, various features and aspects of the embodiments described above may be combined to provide further embodiments. In addition, the foreign patent application listed in the Application Data Sheet, namely, German patent application DE 10 2017 109 103.3, filed Apr. 27, 2017, is incorporated herein by reference in its entirety. Aspects of the embodiments can be modified, if necessary, to employ concepts of the application to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. An LED panel, which has at least one illuminant, and wherein:
the panel has contact-connection means, which can be used to electrically connect the panel to at least one further panel,
the contact-connection means is a multipole plug-type connector, and
the panel has a unit, which can be used to displace the contact-connection means.

2. The LED panel according to claim 1, wherein, the unit is configured to make it possible to displace the contact-connection means vertically between a connected state and a disconnected state.

3. The LED panel according to claim 2, wherein in the connected state, the unit mechanically and electrically connects the panel to a further panel.

4. The LED panel according to claim 2, wherein, in the disconnected state, the unit mechanically and electrically disconnects the panel from a further panel.

5. The LED panel according to claim 2, wherein, in the disconnected state, the panel can be removed completely from a group of panels.

6. The LED panel according to claim 1, wherein the unit is configured to be displaced by a tool.

7. The LED panel according to claim 1, wherein the unit has a spring element.

8. The LED panel according to claim 7, wherein the spring element is a torsion spring.

9. The LED panel according to claim 1, wherein the unit can be operated from a front side and/or a rear side of the panel.

10. The LED panel according to claim 1, wherein the contact-connection means is a hybrid plug-type connector for transmitting power and/or data and/or signals.
